(19) United States
(12) Patent Application Publication
(10) Pub. No.: US 2023/0253775 A1
(43) Pub. Date: Aug. 10, 2023

(54) ELECTRONIC DEVICE AND PROTECTION CIRCUIT THEREOF

(71) Applicant: Qisda Corporation, Taoyuan City (TW)

(72) Inventor: Yuag-Ting FANG, Taoyuan City (TW)

(73) Assignee: Qisda Corporation, Taoyuan City (TW)

(21) Appl. No.: 17/715,185

(22) Filed: Apr. 7, 2022

(30) Foreign Application Priority Data
Feb. 7, 2022 (CN) 202210120232.5

(51) Int. Cl. H02H 3/02; H02M 1/00; H02M 1/08; H02H 3/20

(52) U.S. Cl. CPC H02H 3/021; H02H 3/20; H02M 1/0003; H02M 1/08

(57) ABSTRACT

An electronic device includes a voltage transformation circuit, a back-end circuit, a feedback circuit and a protection circuit. The voltage transformation circuit is configured for outputting a conversion voltage. The feedback circuit is electrically coupled to the back-end circuit and the voltage transformation circuit and is configured for outputting a feedback voltage of the conversion voltage. The protection circuit is electrically coupled to the voltage transformation circuit and the back-end circuit and is configured for detecting the feedback voltage, and outputting a control signal to the voltage transformation circuit according to the feedback voltage.

This application claims the benefit of People’s Republic of China application Serial No. 202210120232.5, filed on Feb. 7, 2022, the subject matter of which is incorporated herein by reference.

### TECHNICAL FIELD

The disclosure relates in general to an electronic device and a protection circuit thereof.

### BACKGROUND

A transformer could step up or step down a power supply voltage into a conversion voltage, and the conversion voltage is converted into a feedback voltage by a feedback circuit for use of a circuit board. However, general protection chip only detects the front-end circuit. When the transformer or the feedback circuit is aged or damaged and abnormality of the front-end circuit is detected, back-end circuit is possible to be burned (or even cause smoke or fire) due to the feedback voltage is abnormally increased. Therefore, how to protect the back-end circuit is an important issue for those skilled in the art.

### SUMMARY

According to an embodiment, an electronic device is provided. The electronic device includes a voltage transformation circuit, a back-end circuit, a feedback circuit and a protection circuit. The voltage transformation circuit is configured for outputting a conversion voltage. The feedback circuit electrically couples the back-end circuit with the voltage transformation circuit and is configured for outputting a feedback voltage of the conversion voltage. The protection circuit is electrically coupled to the voltage transformation circuit and the back-end circuit and configured for detecting the feedback voltage and outputting a control signal to the voltage transformation circuit according to the feedback voltage.

According to an embodiment, a protection circuit is provided. The protection circuit is adapted to be electrically coupled to a feedback circuit, a back-end circuit and a voltage transformation circuit, wherein the feedback circuit electrically couples the back-end circuit with the voltage transformation circuit, and the protection circuit includes a comparator and a reference voltage. The comparator has an input terminal, an output terminal and a reference terminal, wherein the output terminal is electrically coupled to a voltage transformation circuit, the input terminal is electrically coupled to a feedback voltage from the feedback circuit for detecting the feedback voltage, and the comparator outputs a control signal to the voltage transformation circuit according to the feedback voltage. The reference voltage is electrically coupled to the reference terminal.

According to an embodiment, an electronic device is provided. The electronic device includes a voltage transformation circuit, an in-vehicle product, a feedback circuit and a protection circuit. The voltage transformation circuit is configured for outputting a conversion voltage. The in-vehicle product includes a back-end circuit. The feedback circuit electrically couples the back-end circuit with the voltage transformation circuit and is configured for outputting a feedback voltage of the conversion voltage. The protection circuit is electrically coupled to the voltage transformation circuit and the back-end circuit and configured for detecting the feedback voltage and outputting a control signal to the voltage transformation circuit according to the feedback voltage.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 illustrates a functional block diagram of an electronic device according to an embodiment of the present invention;

FIG. 2 illustrates a functional block diagram of a protection circuit of FIG. 1.

FIG. 3A illustrates a functional block diagram of a protection circuit according to another embodiment of the present invention; and

FIG. 3B illustrates a schematic diagram of a transition circuit of FIG. 3A.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

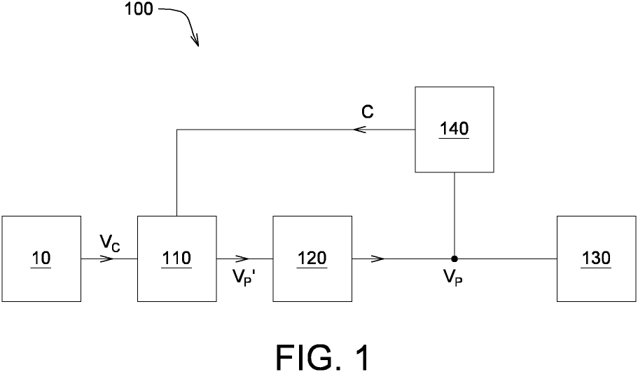

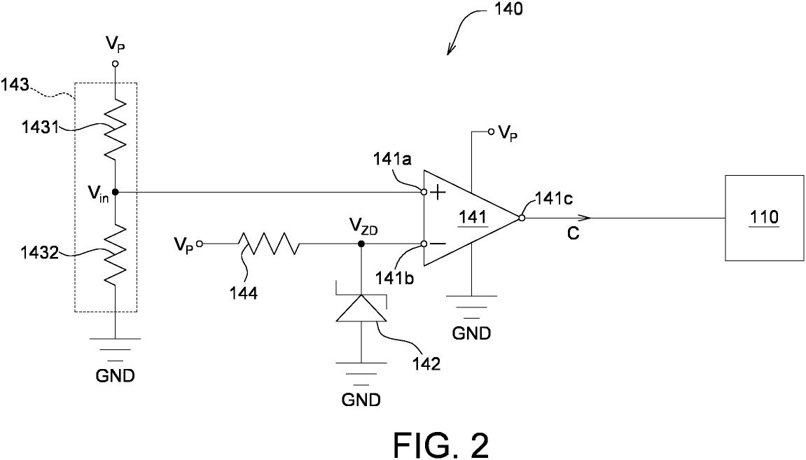

Referring to FIGS. 1 and 2, FIG. 1 illustrates a functional block diagram of an electronic device 100 according to an embodiment of the present invention, and FIG. 2 illustrates a functional block diagram of a protection circuit 140 of FIG. 1. The electronic device 100 could be applied to, for example, an in-vehicle product or other electronic product. The in-vehicle product is, for example, a vehicle-mounted circuit board or other parts assembled in vehicle.

As shown in FIG. 1, the electronic device 100 includes a voltage transformation circuit 110, a feedback circuit 120, a back-end circuit 130 and a protection circuit 140. The back-end circuit 130 could be disposed on the in-vehicle product, or the in-vehicle product includes the back-end circuit 130, but the embodiment of the present invention is not limited thereto. In an embodiment, the in-vehicle product could belong to the electronic device 100. The electronic device 100 could be electrically coupled to a power source 10, wherein the power source 10 is, for example, a commercial power supply, a battery, etc. The power supply 10 provides a voltage V_{c} to the electronic device 100. The voltage transformation circuit 110 steps up or steps down the voltage Vc into a conversion voltage V_{P}’, and the feedback circuit 120 converts the conversion voltage V_{P}’ into a feedback voltage V_{P} required by the back-end circuit 130. The back-end circuit 130 includes, for example, at least a central processing unit (CPU) and/or other electronic element which is located at the back-end of a circuit transmission path of the feedback circuit 120 or is electrically coupled to the feedback circuit 120. The feedback voltage V_{P} is proportional to the conversion voltage V_{P}’, so it could be determined whether the conversion voltage V_{P}’ is abnormal according to the value of the feedback voltage V_{P}. For example, if the conversion voltage V_{P}’ is abnormal, the feedback voltage V_{P} is also be abnormal; otherwise, the conversion voltage V_{P} is normal, the feedback voltage V_{P} is also normal.

As shown in FIG. 1, the voltage transformation circuit 110 could output the conversion voltage V_{P}’. The feedback circuit 120 is electrically coupled to the back-end circuit 130 and the voltage transformation circuit 110 and is configured for outputting the feedback voltage V_{P} of the conversion voltage V_{P}’. The protection circuit 140 is electrically coupled to the voltage transformation circuit 110 and the back-end circuit 130 and is configured for detecting the feedback voltage V_{P} and outputting a control signal C to the voltage transformation circuit 110 according to the feedback voltage V_{P}. The protection circuit 140 outputs, in response to the state of the feedback voltage V_{P}, a corresponding control signal C to the voltage transformation circuit 110 for protecting the back-end circuit 130.

At least one of the voltage transformation circuit 110, the feedback circuit 120, the back-end circuit 130 and the protection circuit 140 is, for example, a physical circuit formed by a semiconductor process. The voltage transformation circuit 110 includes, for example, a Flyback converter, a Forward converter or other types of voltage conversion converters.

In an embodiment, the voltage transformation circuit 110 is configured to enable or disable the output of the conversion voltage V_{P}’ according to the control signal C. For example, when the feedback voltage V_{P} is abnormal, the output of the control signal C is at a first level, and accordingly the voltage transformation circuit 110 disables the output of the conversion voltage V_{P}’ to prevent the feedback voltage V_{P} from damaging the back-end circuit 130. When the feedback voltage V_{P} is normal, the output of the control signal C is at a second level, the transformer converting circuit 110 enables the output of the conversion voltage V_{P}’. The first level of the embodiment of the present invention is, for example, a high level, and the second level is, for example, a low level however, such exemplification is not meant to be for limiting.

As shown in FIG. 2, the protection circuit 140 includes a comparator 141, a reference voltage VZD, a diode 142, a voltage dividing unit 143 and a resistor 144 (optional). The comparator 141 has an input terminal 141a, a reference terminal 141b and an output terminal 141c. The output terminal 141c is electrically coupled to the voltage transformation circuit 110, and the input terminal 141a is electrically coupled to the feedback voltage V_{P}. The reference voltage V_{ZD} is electrically coupled to the reference terminal 141b. In the present embodiment, the reference voltage V_{ZD} is, for example, a voltage obtained by the feedback voltage V_{P} being acted through the resistor 144. In another embodiment, the reference terminal 141b could also be directly referenced to the reference voltage V_{ZD} without being coupled to the feedback voltage V_{P} and the resistor 144, and, in this example, the protection circuit 140 could omit the resistor 144 and/or the feedback voltage V_{P} coupled to the resistor 144.

As shown in FIG. 2, the diode 142 electrically couples the reference terminal 141b with the feedback voltage V_{P}. The voltage dividing unit 143 electrically couples the feedback voltage V_{P} with a low potential GND, and the partial voltage Vᵢₙ of the feedback voltage V_{P} is electrically coupled to the input terminal 141a. The potential of the low potential GND is lower than the feedback voltage V_{P} and the reference voltage V_{ZD}, and the low potential GND is, for example, grounding potential. The voltage dividing unit 143 includes a first resistor 1431 and a second resistor 1432. The first resistor 1431 is electrically coupled to the feedback voltage V_{P}. The second resistor 1432 electrically couples the first resistor 1431 with the low potential GND. The partial voltage Vᵢₙ is a voltage of a node between the first resistor 1431 and the second resistor 1432. Due to the functions of the first resistor 1431 and the second resistor 1432, the partial voltage Vᵢₙ is less than the feedback voltage V_{P}. When the feedback voltage V_{P} is in the normal range, the partial voltage Vᵢₙ is smaller than the reference voltage V_{ZD} (or the feedback voltage V_{P}), so the level of the control signal C which is output from the output terminal 141c is the second level. The control signal C of the second level maintains the current working mode according to the control signal C having the second level. Conversely, when the feedback voltage V_{P} exceeds the aforementioned normal range (that is, the feedback voltage V_{P} is abnormal), the partial voltage Vᵢₙ increases with the increase of the feedback voltage V_{P}, so that the partial voltage Vᵢₙ is greater than the reference voltage V_{ZD}, and the level of the control signal C which is output from the output terminal 141c is changed to be the first level. The voltage transformation circuit 110 disables the output of the conversion voltage V_{P}’ according to the control signal C having the first level, that is, voltage transformation circuit 110 cuts off the output of the conversion voltage V_{P}’ (equivalent to cutting off the output of the feedback voltage V_{P}) to prevent the feedback voltage V_{P} from damaging the back-end circuit 130.

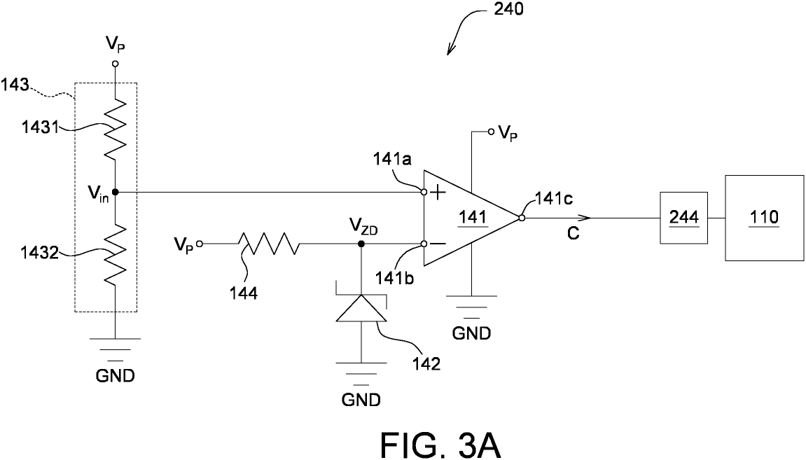

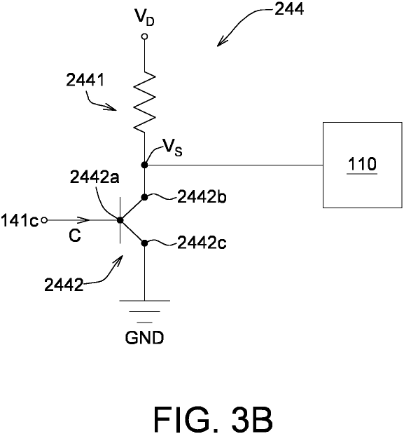

Referring to FIGS. 3A and 3B, FIG. 3A illustrates a functional block diagram of a protection circuit 240 according to another embodiment of the present invention, and FIG. 3B illustrates a schematic diagram of a transition circuit 244 of FIG. 3A.

The protection circuit 240 could replace the protection circuit 140 of the electronic device 100 of FIG. 1. The protection circuit 240 includes the comparator 141, the reference voltage V_{ZD}, the diode 142, the voltage dividing unit 143, the resistor 144 and a transition circuit 244. The protection circuit 240 has the same or similar features as the aforementioned protection circuit 140 except that the protection circuit 240 further includes the transition circuit 244, and the transition circuit 244 could change the level of the signal.

As shown in FIG. 3A, the transition circuit 244 is electrically coupled to the output terminal 141c of the comparator 141 and the voltage transformation circuit 110, and is configured to change the level of the control signal C. For example, the transition circuit 244 converts the first level of the control signal C output from the output terminal 141c to the second level. In the present embodiment, the voltage transformation circuit 110 disables the output of the conversion voltage V_{P}’ (the conversion voltage V_{P}’ is shown in FIG. 1) according to the control signal C having the second level, that is, the voltage transformation circuit 110 cuts off the output of the conversion voltage V_{P}’ (equivalent to cutting off the output of the feedback voltage V_{P}) to prevent the feedback voltage V_{P} from damaging the back-end circuit 130.

As shown in FIG. 3B, the transition circuit 244 includes a resistor 2441 and a transistor 2442. A gate 2442a of the transistor 2442 is coupled to the output terminal 141c, a source 2442b of the transistor 2442 couples the resistor 1441 with the voltage transformation circuit 110, and a drain 2442c of the gate 2442a is coupled to the low potential GND. The resistor 1441 is coupled to the voltage V_{D}. The voltage V_{D} is, for example, a fixed voltage (constant voltage), the feedback voltage V_{P} or a general-purpose input/output (GPIO). When the voltage V_{D} is GPIO, the resistor 2441 could be omitted. In the present embodiment, when the control signal C outputs the second level (the feedback voltage V_{P} is normal), the voltage V_{S} of the source 2442b is normally or regularly maintained at the first level; when the control signal C outputs the first level (the feedback voltage is abnormal), the voltage Vs of the source 2442b is converted to the second level from the first level under the action of the transistor 2442.

To sum up, an embodiment of the present invention provides an electronic device and a protection circuit thereof. The protection circuit is coupled to the front-end of the back-end circuit and the voltage transformation circuit. The protection circuit could detect the value of the feedback voltage and accordingly output the control signal. The control signal could determine whether the voltage transformation circuit maintains or cuts off the output of the current conversion voltage. When the value of the feedback voltage is abnormal, the voltage transformation circuit cuts off the output of the current conversion voltage to protect the back-end circuit. Compared with the conventional electronic device, the electronic device of the embodiment of the present invention could quickly (or promptly) cut off the output of the conversion voltage (or the feedback voltage). In the conventional electronic device, the protection chip only detects the voltage of the front-end circuit and cuts off the voltage output to the back-end circuit when the front-end voltage is abnormal, wherein the response time for cutting off the voltage output is as long as 18 microseconds or even longer. In the electronic device of the embodiment of the present invention, the response time of the protection circuit from detecting the abnormal feedback voltage to the voltage output cut off by the voltage transformation circuit could be as short as 1 microsecond or even shorter. The faster the response speed is, the shorter the time for the abnormal feedback voltage acting on the back-end circuit is, and thus the damage to the back-end circuit is less.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. An electronic device, comprising:
a voltage transformation circuit configured for outputting a conversion voltage;
a back-end circuit;
a feedback circuit electrically coupling the back-end circuit with the voltage transformation circuit, and configured for outputting a feedback voltage of the conversion voltage;
a protection circuit electrically coupled to the voltage transformation circuit and the back-end circuit and configured for:
detecting the feedback voltage; and
outputting a control signal to the voltage transformation circuit according to the feedback voltage.

2. The electronic device according to claim 1, wherein the voltage transformation circuit is configured for:
enabling or disabling output of the conversion voltage according to the control signal.

3. The electronic device according to claim 1, wherein the protection circuit comprises:
a comparator having an input terminal, an output terminal and a reference terminal, wherein the output terminal is electrically coupled to the voltage transformation circuit, and the input terminal is electrically coupled to the feedback voltage; and
a reference voltage electrically coupled to the reference terminal.

4. The electronic device according to claim 3, wherein the protection circuit further comprises:
a diode electrically coupling the reference terminal with the feedback voltage.

5. The electronic device according to claim 3, wherein the protection circuit further comprises:
a voltage dividing unit electrically coupling the feedback voltage with a low potential, wherein a partial voltage of the feedback voltage is electrically coupled to the input terminal.

6. The electronic device according to claim 5, wherein the voltage dividing unit comprises:
a first resistor electrically coupled to the feedback voltage; and
a second resistor electrically coupling the first resistor with the low potential;
wherein the partial voltage is a voltage of a node between the first resistor and the second resistor.

7. The electronic device according to claim 3, wherein the protection circuit further comprises:
a transition circuit electrically coupled to the output terminal and configured for changing a level of the control signal.

8. The electronic device of claim 5, wherein when the partial voltage is greater than the reference voltage, the output terminal outputs the control signal, and the level of the control signal is a first level.

9. The electronic device of claim 5, wherein when the partial voltage is greater than the reference voltage, the output terminal outputs the control signal; the level of the control signal is a first level, and the protection circuit further comprises:
a transition circuit electrically coupled to the output terminal and the voltage transformation circuit and configured for converting the first level of the control signal output from the output terminal into a second level.

10. A protection circuit adapted to be electrically coupled to a feedback circuit, a back-end circuit and a voltage transformation circuit, wherein the feedback circuit electrically couples the back-end circuit with the voltage transformation circuit, and the protection circuit comprises:
a comparator having an input terminal, an output terminal and a reference terminal, wherein the output terminal is electrically coupled to a voltage transformation circuit, the input terminal is electrically coupled to a feedback voltage from the feedback circuit for detecting the feedback voltage, and the comparator outputs a control signal to the voltage transformation circuit according to the feedback voltage; and
a reference voltage electrically coupled to the reference terminal.

11. The protection circuit according to claim 10, further comprising:
a diode electrically coupling the reference terminal with the feedback voltage.

12. The protection circuit according to claim 10, further comprising:
a voltage dividing unit electrically coupling the feedback voltage with a low potential, wherein a partial voltage of the feedback voltage is electrically coupled to the input terminal.

13. The protection circuit of claim 12, wherein the voltage dividing unit comprises:
a first resistor electrically coupled to the feedback voltage; and
a second resistor electrically coupling the first resistor with the low potential;
wherein the partial voltage is a voltage of a node between the first resistor and the second resistor.

14. The protection circuit of claim 10, wherein the protection circuit further comprises:
a transition circuit electrically coupled to the output terminal and configured for changing a level of the control signal.

15. The protection circuit of claim 12, wherein when the partial voltage is greater than the reference voltage, the output terminal outputs the control signal, and the level of the control signal is a first level.

16. The protection circuit of claim 12, wherein when the partial voltage is greater than the reference voltage, the output terminal outputs the control signal; the level of the control signal is a first level, and the protection circuit further comprises:
a transition circuit electrically coupled to the output terminal and the voltage transformation circuit and configured for converting the first level of the control signal output from the output terminal into a second level.

17. An electronic device, comprising:
a voltage transformation circuit configured for outputting a conversion voltage;
an in-vehicle product comprising a back-end circuit;
a feedback circuit electrically coupling the back-end circuit with the voltage transformation circuit and configured for outputting a feedback voltage of the conversion voltage;
a protection circuit electrically coupled to the voltage transformation circuit and the back-end circuit and configured for:
detecting the feedback voltage; and
outputting a control signal to the voltage transformation circuit according to the feedback voltage.

18. The electronic device of claim 17, wherein the voltage transformation circuit is configured for:
enabling or disabling output of the conversion voltage according to the control signal.

19. The electronic device of claim 17, wherein the protection circuit comprises:
a comparator having an input terminal, an output terminal and a reference terminal, wherein the output terminal is electrically coupled to the voltage transformation circuit, and the input terminal is electrically coupled to the feedback voltage; and
a reference voltage electrically coupled to the reference terminal.

20. The electronic device of claim 17, wherein the protection circuit further comprises:
a voltage dividing unit electrically coupling the feedback voltage with a low potential, wherein a partial voltage of the feedback voltage is electrically coupled to the input terminal, and when the partial voltage is greater than the reference voltage, the output terminal outputs the control signal, and the level of the control signal is a first level.
